(19) United States
(12) Patent Application Publication
(10) Pub. No.: US 2014/0072940 A1
(43) Pub. Date: Mar. 13, 2014

(54) CPR TRAINING DEVICE AND METHOD OF USE

(71) Applicant: Harrill D. Wood, Talking Rock, GA (US)

(72) Inventor: Harrill D. Wood, Talking Rock, GA (US)

(21) Appl. No.: 13/608,338

(22) Filed: Sep. 10, 2012

(51) Int. Cl. G09B 23/28

(52) U.S. Cl. 434/265

(57) ABSTRACT

A CPR training device for simulating continuous chest compressions has a weight measuring scale with a visual indicator of applied force or weight. The visual indicator includes a graduated measuring scale measuring 0 pounds to at least 140 pounds; and a pointer or needle movable in response to an applied force or weight. The CPR training device visually shows the applied force of each compression. The CPR training device has a top surface having a label. The label is adhered to the top surface and has a target zone identifying the location CPR compressions are to be applied. The target zone is preferably graphically depicted in the shape of a heart.

### FIELD OF THE INVENTION

A training device for teaching how to administer continuous chest compressions is disclosed. The device shows the user the applied force in pounds delivered during each compression.

### BACKGROUND OF THE INVENTION

Continuous Chest Compression “CCC” is now the preferred intervention procedure for treating a person suffering from a heart attack. It was determined that the previous procedure of providing mouth to mouth resuscitation between compressions was not as effective as continuous compressions only. This was particularly the case when only one person was available to perform Cardio-Pulmonary Resuscitation “CPR”.

This greatly simplifies the administration of CPR. Typically, classes are provided to teach the proper technique. Certificates are earned by those who complete the classes successfully.

The problem with such programs is the student needs a reliable and safe way to provide proper compressions. To achieve a good result, the downward stroke or compression should deflect the breastbone about 2 inches. This amount of deflection yields about 120 lbs of compression. These compressions need to be delivered at 100 per minute.

As one can imagine, the ability to deliver such a lifesaving treatment requires some strength and stamina. These compressions must continue until the patient is revived or medical assistance arrives. Typically, this can take from four minutes to as many as 10 minutes or more for paramedics to reach a patient. The person delivering CPR over such a long period can slow down or reduce the force making the CPR treatment far less effective.

The inventor of the present invention had previously invented a “CPR Assist Device” to enable the user to easily provide CPR.

The invention entitled “A Manual CPR Or CCC Continuous Chest Compression Assist Device” was filed on May 16, 2012 as U.S. patent application Ser. No. 13/73,155, the contents of which are incorporated by reference herein in their entirety.

This CPR assist device allows the user's hands to be elevated making the delivery of the chest compressions easier while simultaneously delivering a more focused force to the heart thereby improving the pumping action.

The invention, while greatly improving CPR delivery and simplifying its use, allows people untrained in the delivery of CPR to be trained more quickly and with far greater reliability. Typically, medical dummies used in CPR training provide no information as to deflection and rate and pounds of force delivered.

The present invention provides a unique and simple way to provide training with real time feedback to the student or trainee.

It was an object of the present invention to provide a device that indicates the pounds delivered on each stroke.

It was a further object to provide a timing means to assist in achieving a rate of delivery in the 100 compressions per minute range.

It was a further objective to achieve this capability in a low cost effective training device.

These and other objectives are achieved by the invention described herein.

### SUMMARY OF THE INVENTION

A CPR training device for simulating continuous chest compressions has a weight measuring scale with a visual indicator of applied force or weight. The visual indicator includes a graduated measuring scale measuring 0 pounds to at least 140 pounds; and a pointer or needle movable in response to an applied force or weight. The CPR training device visually shows the applied force of each compression. The CPR training device has a top surface having a label. The label is adhered to the top surface and has a target zone identifying the location CPR compressions are to be applied. The target zone is preferably graphically depicted in the shape of a heart.

An optimal load indicator second label is affixed adjacent the graduated scale spanning 120 to 140 pounds on the scale. The label has a rate indication of 100/min positioned near the visual indicator.

The CPR training device may have a timing meter device. The timing meter device is adjustable to vary beats per minute. The timing meter device has a visual indicator that can be set to 100/min to reflect the optimal rate of chest compressions. The timing meter device also has an audible sound set to the rate selected controlled by a switch or on-off button on the timing meter device.

The CPR training device of claim 1 further may include a CPR assist device. The preferred CPR training device uses a CPR assist device. The CPR assist device includes an audible click and echo that sounds a click when compressed and echoes when released to indicate a reset condition, wherein the CPR training device visually shows the applied force of each compression and the timing device provides a visual or audible rate indication to the user of his or her rate of compressions. The CPR training device ideally prompts the rate of compressions to be adjusted to the rate of the timing meter device. The CPR training device shows an optimal compression in the range of 120-140 pounds at a rate of 100 compressions per minute and repeated training with the device conditions the user to administer compressions at the optimal rate and load.

A method of teaching proper CPR continuous chest compressions has the steps of a) providing a weight measuring scale; b) applying a downward force on a top surface of the weight measuring scale in an amount between 120 and 140 pounds while observing the visual indicator reading thereby simulating a chest compression; c) relaxing, allowing the indicator to reset to zero pounds; d) reapplying the downward force, then relaxing repeatedly at a rate approximately 100 compressions per minute. The method further has the step of providing a CPR assist device and using the CPR assist device to apply the simulated compressions. The method further has the step of providing a timing meter device with a rate indicator that is visual or audible or both and synchronizing the rate of simulated compressions to the rate set on the timing meter device. Preferably, the rate of the timing meter device is set to 100 per minute. The method when using the CPR assist device has an audible click and echo sound that clicks on each downward compression and echoes on relaxation, and the method further has the step of matching the click sound to the visual or audible sound of the timing meter device thereby achieving a set rate of compressions per minute, preferably 100 per minute.

### BRIEF DESCRIPTION OF THE DRAWINGS

The invention is described by way of example and with reference to the accompanying drawings in which:

FIG. 1 is a perspective view of the training device made in accordance to the present invention according to a first embodiment of the present invention.

FIG. 2 is a top view looking at the training device of FIG. 1.

FIG. 3 is a side view of the training device.

FIG. 4 is a view of the training device with the tethered CPR assist unit removed and the timing meter removed shown to the side of the training device.

FIG. 5 is an illustration of the training device in use.

### DETAILED DESCRIPTION OF THE INVENTION

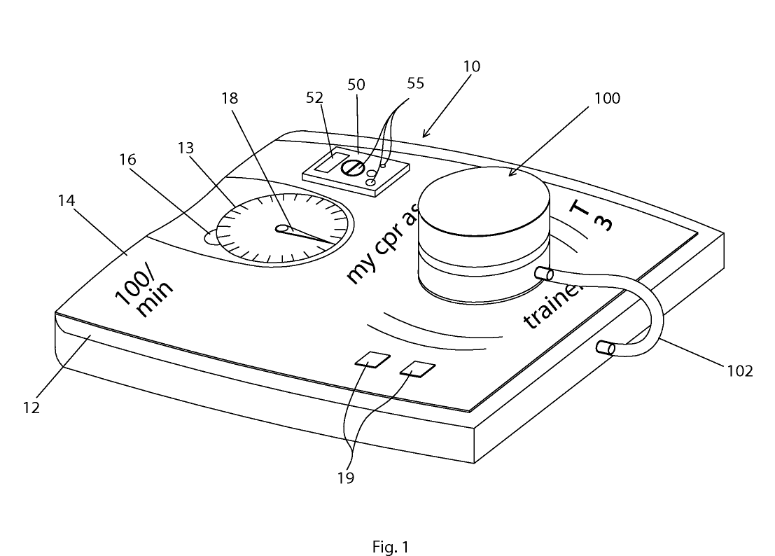

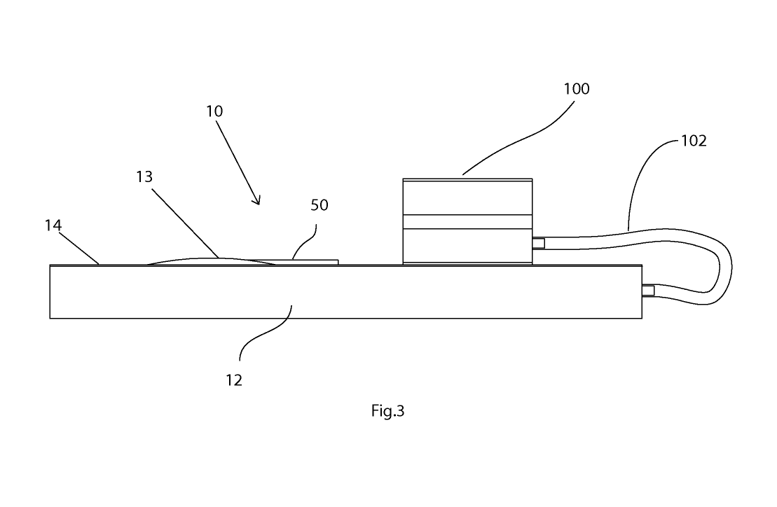

With reference to FIGS. 1-5, a first embodiment of the present invention is illustrated. This first embodiment illustrates a CPR training device. This CPR training device 10 has a weight scale measuring apparatus 12 which measures weight or pounds of force applied to the scale. The scale 12 employs a graduated measuring scale 13 of weight from 0 to 300 pounds as illustrated. This graduated scale 13 in increments of 20 pounds and has an indicator 18 which rotates upon the application of force to the scale 12. The indicator 18 indicates the pound load applied to the scale 12. As further indicated, a label 16 is applied at the weight ranges of 120 to approximately 150 as illustrated, preferably 120-140. This amount of weight or pounds force is the optimal weight that should be applied to the chest during CPR compressions. When a load is applied the indicator 18 will move to the load. When the load is released the indicator 18 moves back to the zero point.

As shown, on the top surface of the scale 12 is a label 14. This label 14 is preferably a plastic laminate label that is adhesively affixed at the top surface of the scale 12. As shown, the label 14 has an indication of 100 per minute in an upper left hand corner of the label 14. At an upper center portion of the label 14 a clear or transparent section is applied over the graduated scale 13 and indicator 18 of the scale 12 so the visual indication can be easily observed. At the right upper corner is a timing meter 50 that can either be adhesively affixed using hook and loop attachments secured to the label 14 or can be simply placed on the weight measuring scale 12 as indicated.

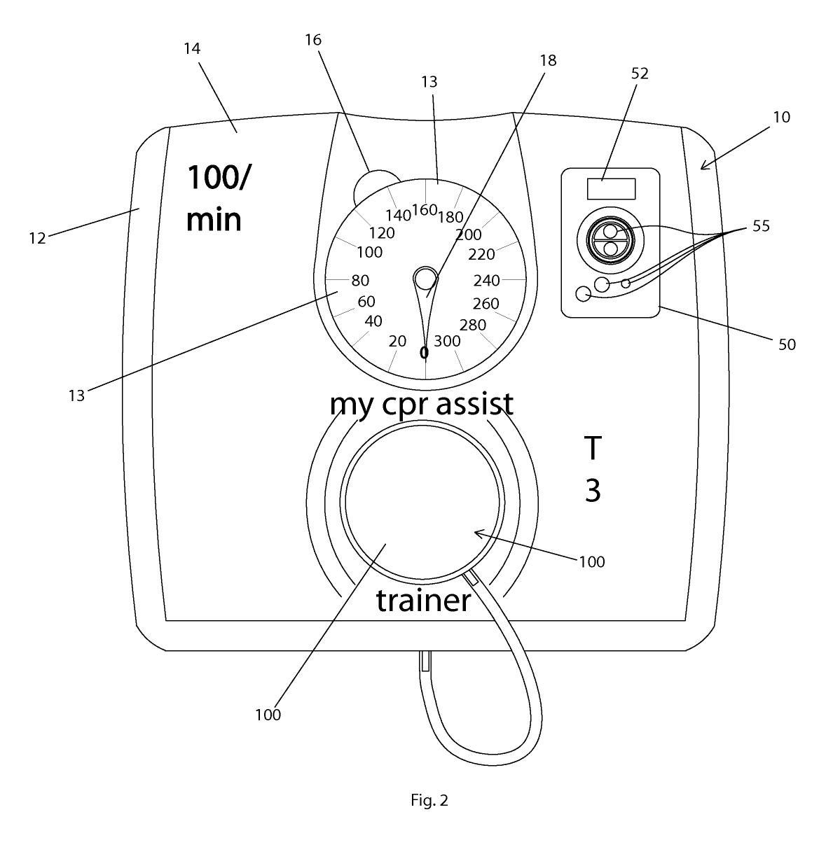

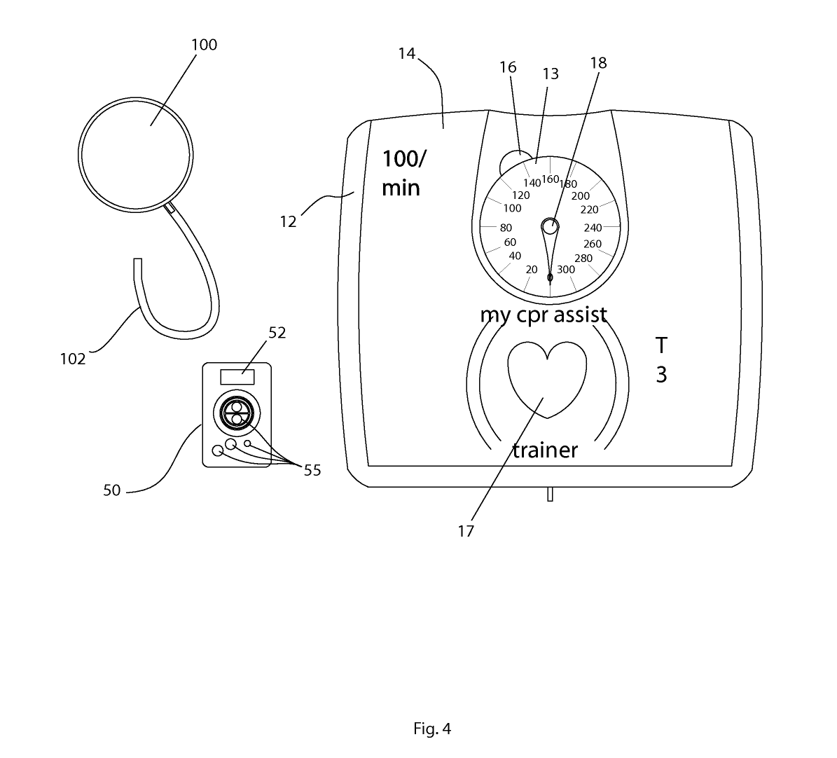

With reference to the lower portion of the training device 10, a CPR assist device 100 is illustrated in FIG. 2. The CPR assist device 100 has a tether 102 attached to both the scale 12 and the CPR assist device 100 so that the CPR assist device 100 can be maintained with the training device 10. As shown in FIG. 1, two hook and loop fasteners 19 can optionally be provided to stow the CPR assist device 100 onto the scale 12. It is further noted that corresponding or mating fasteners 19 are affixed to the bottom of the CPR assist device 100 to allow for this stowing. When the hook and loop fasteners 19 are used the tether 102 can be eliminated altogether if desired. This makes replacing worn out CPR assist devices 100 even easier. These components are further illustrated in FIG. 4 which is a view showing the components separated from the scale 12. The timing meter 50 is shown having a window 52 wherein a visual indication of timing and rate can be observed through the window. In addition, the timing meter 50 has an audio sound that can be activated by the switches 55 as illustrated. The purpose of this timing meter device 50 will be discussed later. The CPR assist device 100 is as described in co-pending U.S. application Ser. No. 13/473,155 entitled “A Manual CPR Or CCC Continuous Chest Compression Assist Device” filed on May 16, 2012.

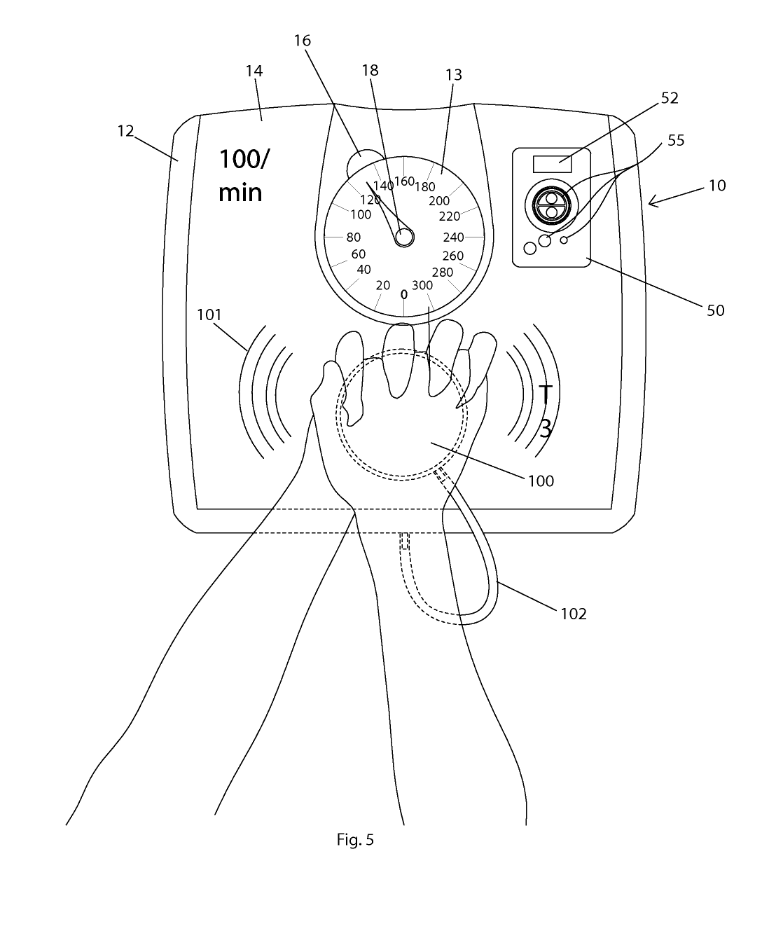

It is important to recognize as illustrated in FIG. 4, that the CPR training device 10 can be sold as a separate unit without the CPR assist device 100 and the timing device 50 each of which can be purchased separately. It is important to note that training device scale 12 provides a visual indication of the optimal range with a red load label 16 which indicates when a person compressing on the scale is providing a proper amount or optimum compression for CPR. It has been determined that approximately a 2 inch deflection of the breast bone of a patient suffering a cardiac arrest is sufficient deflection to achieve the desired pumping action. This pumping action is optimally achieved by maintaining a rate of approximately 100 compressions per minute at a load of between 120 and 140 pounds optimally. In order to simulate this as illustrated in FIG. 5, the CPR assist device 100 is placed on the unit 10 above the heart shaped target zone 17 shown in FIG. 4. The depicted heart 17 is the target zone wherein the compression force is to be applied. This compression force can be applied using hands only without a CPR assist device 100. If this is done, one will notice quickly that the hands can easily become fatigued. This is actually the case when one is performing CPR on a cardiac arrest patient. The fatigue factor is tremendously increased without the use of a CPR assist device 100. Therefore, it is recommended to use the trainer 10 with the CPR assist device 100 as illustrated in FIG. 5. As the compressions are made, the CPR assist device 100 makes a clicking sound that clicks when a full compression is achieved on the device such that a force is applied that will optimally be in a range of 120 to 140 pound force. This occurs when the beats or compressions per minute are paced at approximately 100 beats per minute. As illustrated in FIG. 5, the echo or sound click 101 is made on compression and the echo occurs on release. Therefore, when the user hears the first click he knows to relax and as he relaxes the second click is emitted from the CPR assist device 100 to indicate that the device 100 is reset and ready for the next compression. As can be appreciated, this occurs rather quickly, in fact in less than 1 second, preferably a little more than a ½ second is used between compressions.

What is difficult in administration of CPR is that a person inexperienced in CPR compression may be applying the proper amount of force, but not at the optimal rate. In order to maintain the optimal rate, it has been determined that a timing metering device 50 should be used in conjunction with the training device 10. This metering device 50 preferably has a window 52 from which visual dots are transposed across the window 52. As the dots move from one side of the window 52 to the other, the person continues to click repeatedly compressing and then relaxing, preferably in rhythm with the moving dots. If this occurs, the entire device 10 will be working at the optimal rate and will be delivering the optimal pounds pressure condition. In order to further facilitate the timing ability of the training individual, the timing metering device 50 has not only a visual indication of rate, but also an audio signal that can activated by pressing one or more of the switches 55, when this occurs a beeping sound occurs every time a compression should be made. In this case, the training individual 2 tries to do a downward compression in beat with the timing meter 50. When this is achieved, the optimal rate of 100 beats per minute can be established. The advantage of doing this means that as the trainee 2 practices as he continues to get in rhythm with the beats of the timing meter 50 and will get more competent and experienced so that it becomes second nature to provide the compressions at the optimal rate. Additionally, as the rate optimality is achieved, it is noticed that the CPR assist device 100 automatically performs in the optimal range.

It has been noted that if one provides a slow downward pressure on the CPR assist device 100 it may click at a lower pressure, however, when the CPR device 100 is operated at close to the optimal rate, the pound force applied to the measuring scale 12 will be in the optimal range. It is important to understand that the use of the training device 10 not only gives the user experience and high confidence levels, it also gives the user the ability to observe the amount of force being applied. It has been observed that as CPR compression is being administered, the person administering it becomes fatigued rather quickly. This is particularly true when no CPR assist device 100 is used, in such a situation, the operator becomes quickly fatigued in minutes and the amount of force applied is inconsistent. With a CPR assist device 100 has been used in combination with the trainer 10, the level of user consistency of compression is maintained at a much higher level over longer periods of time in actual patient assisting CPR situations. This is important in that in order to bring the patient back to a survivable condition CPR must be provided continuously and must be provided at a deflection of the chest and with the resultant pounds force applied that will achieve a sufficient massaging of the heart in order to achieve adequate reestablishment of blood circulation. These objectives are all achieved with the use of the CPR assist device 100. Additionally, when the CPR assist device 100 is used with the training device 10 as shown it has been determined that inexperienced administrators of CPR become rapidly trained and their experience and confidence level is greatly increased. This is important in that one who has to administer CPR needs to have a high confidence level that they can do the compressions properly. The training device 10 makes the one providing CPR compression much more competent and the survivability of the patient is greatly increased by the improved competency of the person administering the CPR compressions.

While the device 10 of the first embodiment shows the CPR assist device 100 tethered, it must be appreciated that the weight measuring scale 12 can be provided separately from any assist device and that the weight measuring scale 12 can be used with any CPR assist device or can be used manually in the absence of any CPR assist device. In such a case, the operator can attempt to provide CPR using manual hand compressions if so desired. The advantage of this is the CPR training device 10 enables the user to see how much easier CPR can be provided by using the CPR assist device 100. Additionally, the use of the timing metering device 50 can be replaced with any timing meter and can be replaced by a timing meter worn on the wrist of the user if so desired. These alternatives are all available and are within the scope of the present invention. It must be appreciated that while the training device 10 provides both a visual means of establishing the amount of force applied, it also can be used to establish the rate. Alternatively, even if it only provides the amount of force applied, it is a great benefit to those seeking CPR training Advantageously, the device 10 can be created by purchasing only the label 14 that can be separately affixed to any commercially compatible weight scale. This is true in that a CPR training device 10 can be made by converting a conventional weight scale by providing the desired labeling 14 and the label 16 showing the optimal load range. This has the advantage that the user can use his own weight scale and use the device labels to convert it into a CPR training device 10 if so desired. Alternatively, it has been determined that the best mode of practicing the invention, the CPR assist device 100 should come with an assembled training device 10 having all of the necessary components to enable rapid and quick training. It is important that one understand that various alternatives to the device can be made, as for example, the use of the timing device 50 and the CPR assist device 100 as separate elements not included with the weight measuring scale 12 and its associated labeling 14. The weight scale 12 with a graduated measuring scale 13 and indicator 18 is believed best, however, a digital scale could be used if designed to indicate loads in less than a few milliseconds and resets repeatedly. This is still not as good a system alternative because it cannot show the load's upward movement like the indicator 18.

A benefit of the CPR trainer 10 is that the CPR assist device 100 can be removed from the assembly as can the timing meter device 50 and if a cardiac arrest is occurring, this CPR assist device 100 can be used on a patient directly and the timing meter 50 can be placed on the chest of the person receiving CPR and therefore the timing device 50 can be used in an actual cardiac arrest situation if so desired.

The label 14 can be sold separately and thereafter affixed to a weight scale 12. In this case, the label 14 can be affixed or glued directly to the scale to form the CPR training device. The label 14 can have a center cut out or transparent portion for seeing the scale indicator 18. The red load label 16 can be applied as a separate piece or be positioned on the transparent portion of the label 14 to show the 120 to 140 pounds target force. The target zone 17 will preferably be the heart shaped symbol printed on the label 14.

These and other benefits can be achieved by the present invention as illustrated and claimed hereafter.

Variations in the present invention are possible in light of the description of it are provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described, which will be within the full intended scope of the invention as defined by the following appended claims.

What is claimed is:

1. A CPR training device comprising:
a weight measuring scale with a visual indicator of applied force or weight.

2. The CPR training device of claim 1 wherein
the visual indicator includes a graduated scale measuring 0 pounds to at least 140 pounds; and
a pointer or needle movable in response to an applied force or weight.

3. The CPR training device of claim 1 further comprises:
a top surface having a label, the label being adhered to the top surface wherein the label has a target zone identifying the location CPR compressions are to be applied.

4. The CPR training device of claim 2 has an optimal load indicator label adjacent the graduated scale spanning 120 to 140 pounds on the scale.

5. The CPR training device of claim 2 wherein the label has a rate indication of 100/min positioned near the visual indicator.

6. The CPR training device of claim 3 wherein the target zone is graphically depicted in the shape of a heart.

7. The CPR training device of claim 1 further comprises:
a timing meter device, the timing meter device being adjustable to vary beats per minute.

8. The CPR training device of claim 7 wherein the timing meter device has a visual indicator that can be set to 100/min to reflect the optimal rate of chest compressions.

9. The CPR training device of claim 8 wherein the timing meter device has an audible sound set to the rate selected controlled by a switch or on-off button on the timing meter device.

10. The CPR training device of claim 1 further comprises:
a CPR assist device, the CPR assist device includes an audible click and echo that sounds a click when compressed and echoes when released to indicate a reset condition.

11. The CPR training device of claim 1 wherein the CPR training device visually shows the applied force of each compression.

12. The CPR training device of claim 9 further comprises:
a CPR assist device, the CPR assist device includes an audible click and echo that sounds a click when compressed and echoes when released to indicate a reset condition, wherein the CPR training device visually shows the applied force of each compression and the timing device provides a visual or audible rate indication to the user of his or her rate of compressions.

13. The CPR training device of claim 12 wherein the rate of compressions is adjusted to the rate of the timing meter device.

14. The CPR training device of claim 13 wherein the CPR training device shows an optimal compression in the range of 120-140 pounds at a rate of 100 compressions per minute, and repeated training with the device conditions the user to administer compressions at the optimal rate and load.

15. A method of teaching proper CPR continuous chest compressions comprises the steps of:
a) providing a weight measuring scale;
b) applying a downward force on a top surface of the weight measuring scale in an amount between 120 and 140 pounds while observing the visual indicator reading thereby simulating a chest compression;
c) relaxing, allowing the indicator to reset to zero pounds;
d) reapplying the downward force, then relaxing repeatedly at a rate approximately 100 compressions per minute.

16. The method of claim 15 further comprises:
providing a CPR assist device and using the CPR assist device to apply the simulated compressions.

17. The method of claim 16 further comprises:
providing a timing meter device with a rate indicator that is visual or audible or both and synchronizing the rate of simulated compressions to the rate set on the timing meter device.

18. The method of claim 17 wherein the rate of the timing meter device is set to 100 per minute.

19. The method of claim 18 wherein the CPR assist device has an audible click and echo sound that clicks on each downward compression and echoes on relaxation, and the method further comprises the step of:
matching the click sound to the visual or audible sound of the timing meter device thereby achieving a set rate of compressions per minute.

20. The method of claim 19 wherein the set rate of compressions is 100 per minute.

21. A CPR training device comprising:
a label for affixing to a top surface of a weight scale, the label having a target zone indicator showing where the CPR compressions are to be applied and a cutaway opening or transparent central portion to allow a user to see the movement of a scale weight indicator as compressions are applied, the label when affixed to the scale forms the CPR training device.
